(19) United States
(12) Patent Application Publication
(10) Pub. No.: US 2005/0091271 A1
(43) Pub. Date: Apr. 28, 2005

(54) Systems and methods that schematize audio/video data

(76) Inventors: Kasy Srinivas, Sammamish, WA (US); Daniel Plastina, Sammamish, WA (US); Alexander E. Vaschillo, Redmond, WA (US); Christopher K. Brownell, Carnation, WA (US); John W. Terrell, Bothell, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/692,215

(22) Filed: Oct. 23, 2003

(51) Int. Cl. G06F 17/00

(52) U.S. Cl. 707/104.1

(57) ABSTRACT

The present invention provides a novel file management approach. The systems and methods comprise a schema-based file management technique that can be integrated within an operating system to provide application developers an efficient and powerful develop utility to build applications. In addition, the system and methods provide for applications that can be employed uniformly across disparate data (e.g., audio and video data) within the operating environment. The schema can include a base schema that is related to known types of data and derived schema that extend the base schema with respect to one or more characteristics of the data. The schema can be employed to generate APIs that can be employed by users and/or applications to exchange information with a file system. In addition, the systems and methods can include configurable intelligence that can be utilized perform actions and/or make decisions, which can automate processes and/or facilitate data storage and/or management.

### TECHNICAL FIELD

The present invention generally relates to file management, and more particularly to systems and methods that store and manage audio and video data based on rich schema sets.

### BACKGROUND OF THE INVENTION

Computer and electronic-related technological advances over the past several decades have lead the way to the computer-age. For example, advances in transistor technology have enabled fabrication of integrated circuit with virtually twice the number of transistors per square inch (transistor density) every year (Moore's law). Such advances have lead to tremendous gains in processing power and transfer rates (e.g., data, control and address) and reductions in component/board size, power consumption and cost. In addition, advances in Internet and wireless technology have provided users with access to essentially anywhere in the world at any time via a button press or mouse click. Computer designers continue to leverage such progress to develop higher performing, more reliable and affordable computing systems with each new generation.

The foregoing and many other advances have contributed to the evolution of the computer into a cost-effective, powerful and efficient mechanism that can facilitate and expedite daily personal and business activities. For examples, today's computers are routinely utilized in communication (e.g., correspondence such as email, instant messaging, chat rooms, etc.), purchasing, selling, information gathering, analysis, and archiving (e.g., documentation). In addition, today's computers are commonly utilized to access stock quotes (e.g., in real-time), obtain weather forecasts, retrieve directions, stream video, listen to music, obtain play-by-play sports updates and play games (e.g., on-line), for example. Moreover, computer technology has been incorporated into systems such as automotive vehicles, home security, manufacturing processes, cell phones, personal assistants, and cooking apparatuses, to provide intelligent systems that automate or semi-automate control and/or monitoring.

Third party vendors have leveraged such technological breakthroughs to enhance user experience through applications with increased user friendliness, flexibility, options, personalization, reliability, security and speed. Such enhancements typically are achieved through modifications and/or additions of code (e.g., executable, libraries, etc.), which commonly introduce additional files and/or increased application (e.g., aggregation of files) size. Thus, third party application development that exploits the latest technology to provide improvements commonly requires more disk space. However, concurrent advances in memory and other hardware have provided for increased disk capacity and seek time rates, which can accommodate increased application size and/or retrieval of an increased number of disparate files stored throughout memory.

Application development typically includes a substantial investment of time and money to structure and create applications around an existing operating system (OS). For example, developers generally have to understand at least some aspects of the OS architecture in order to build interfaces to communicate with the OS and to exploit OS computing power. In addition, developers usually design and generate unique data stores for common storage abstractions (e.g., representations of People, Places, Times and Events). As a consequence, development via a plurality of third party vendors can result in redundant, or duplicate development efforts that a plurality of sets of data that cannot be shared or utilized outside of the corresponding application; much of the information associated with an application remains locked up in files that are only accessible to the applications, which can lead to groups of non shareable data.

In addition to expending resources to understand and generate applications around an operating system, third party developers are confronted with the higher probability that a modification to the file system or operating system (e.g., revision, path, and the like) or a next generation operating system can render the application incompatible and hence non-functional. For example, a change in the technique in which memory is addressed (e.g., from 16-bit to 64-bit) can render an application virtually incompatible with the operating system. Affected third party vendors would have to invest more resources into understanding operating system nuances and intricacies and retrofitting existing applications or creating new applications, knowing that another operating system revision or generation can lead to another set of unsupported applications.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides systems and methods for a rich file management system that can be integrated within a platform to provide third party developers a mechanism to efficiently develop arbitrary application (e.g., audio and video) front-ends that can be employed uniformly across disparate data (e.g., audio and video) within the operating environment. Conventionally, third-party vendors are tasked with understanding various aspects of an operating environment in order to build applications that can communicate with and operate within the operating system. Such efforts can consume time and resources that can be utilized more efficiently, for example, for application front-end development. Moreover, efforts from different third party vendors competing within a similar market (e.g., music player) can result in redundant or duplicate work that cannot be shared and/or numerous disparate file formats that basically are only compatible with the associated application. The present invention can mitigate such efforts by providing third parties with APIs to build applications around the operating system. In general, the APIs provided typically are based on the various rich schemas that provide for seamless operation on disparate data types such as audio and video data. Thus, third party vendors can utilize the APIs and concentrate on building applications front ends that can enhance the user's experience, while the novel file system manages disparate date.

In one aspect of the present invention, a system is provided that manages files. The system includes a component that coordinates storage and retrieval of information, such as audio and/or video files. The component can employ schema common to virtually all types of data and/or schema (e.g., derived) associated with particular data. Utilizing such schema can provide for efficient and structured storage and management of disparate data such as video, audio, documents, and the like, within a similar storage medium, wherein the data can be seamlessly identified, differentiated and accessed.

In another aspect of the present invention, a data management system is depicted. The system employs various schema (e.g., video and audio) to facilitate storing and/or organizing data, querying data and/or manipulating data within a database. In addition, the system can be utilized in connection with a file management system wherein virtually any and all data can be stored based on a respective schema and/or derivations thereof. In general, when a user and/or application provides data for storage, a suitable schema can be obtained and utilized to facilitate such storage, and when a user and/or application request data, a suitable schema can be obtained to facilitate servicing the request.

In another aspect of the present invention, a system is provided that systematically stores and accesses information. The system comprises an API that can be utilized by a user and/or application to interact with the system. The API is typically generated based on a schema (e.g., audio and video) associated with the data. However, it can be appreciated that a common API can be utilized with a plurality of types of data. The system further comprises intelligence that facilitates storage and retrieval of data.

In yet another aspect of the present invention, methodologies are provided that employ schema in connection with storing and managing files. A first methodology includes receiving a file (e.g., audio and/or video), obtaining an associated schema (e.g., common and customized), and utilizing the schema to store the file within a database. A second methodology provides an API that is generated based on one or more schemas. A developer can build applications around the API wherein a user and/or application can transfer information via a suitable API. Examples of suitable schema include generic, audio and video related schema.

In still other aspects of the present invention exemplary schemas are illustrated. The exemplary schema includes media, audio and video schema. In many instances, the audio and/or video schema can be derived from the media schema.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 illustrates an exemplary file management system, in accordance with an aspect of the present invention.

FIG. 2 illustrates an exemplary schema-based file system, in accordance with an aspect of the present invention.

FIG. 3 illustrates an exemplary data management system, in accordance with an aspect of the present invention.

FIG. 4 illustrates an exemplary system that systematically stores and accesses information, in accordance with an aspect of the present invention.

FIG. 5 illustrates an exemplary methodology that employs a schema in connection with managing files in a database, in accordance with an aspect of the present invention.

FIG. 6 illustrates an exemplary methodology that facilitates user interaction with a database, in accordance with an aspect of the present invention.

FIG. 7 illustrates exemplary associations between schema, in accordance with an aspect of the present invention.

FIG. 8 illustrates an exemplary environment in which the novel aspects of the invention can be employed.

### DETAILED DESCRIPTION OF THE INVENTION

The present invention relates to systems and methods that provide a rich file management system for storing and managing data within a database. The systems and methods can be employed in connection with an operating system to provide application developers with an interface to arbitrarily generate applications that work uniformly across disparate data such as audio and video data. The present invention can reduce the effort a vendor expends interfacing and communicating with an operating system via defining schema and providing APIs therefrom. Thus, third party vendors can concentrate on building applications front ends that can enhance the user's experience.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. As known, a thread can have an associated “context” which is the volatile data associated with the execution of the thread. A thread's context includes the contents of system registers and the virtual address belonging to the thread's process.

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention can be practiced without these specific details. In other instances, well-known structures and devices are shown in block diagram form in order to facilitate describing the present invention.

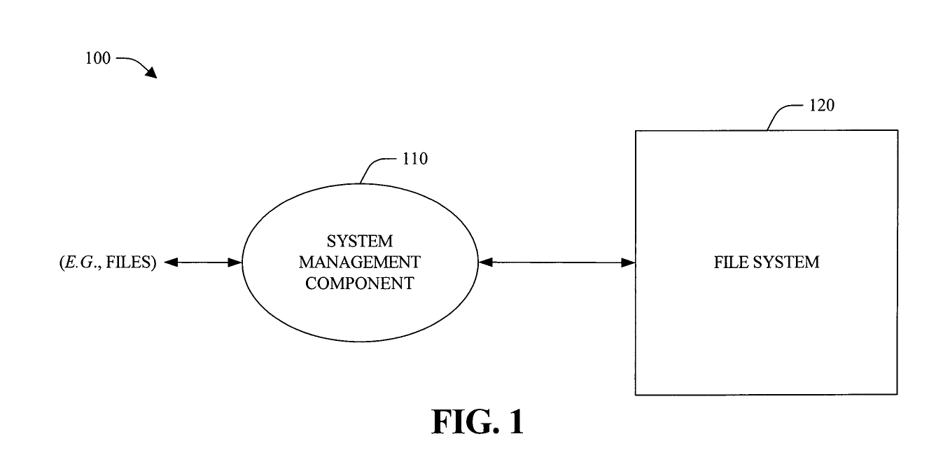

FIG. 1 illustrates a system 100 that manages files, in accordance with an aspect of the present invention. The system 100 comprises a file management component 110, a file system 110 and a log 120. The file management component 110 can receive, store and manage disparate files (e.g., audio, video, image, document, etc.) within the file system 120. In addition, the file management component 110 can establish links with stored information via forming relationships. Such relationships are possible since, unlike conventional systems, disparate information can be managed as an entity rather than as independent data. By way of example, relationships can provide a mechanism to link information such as an author, a picture, a logo, etc. to audio and/or video data. The foregoing provides for information sharing and efficient querying across and within multiple types of data (e.g., disparate) without the having to know the internal structure of the data.

In general, a relationship can be established with one or more contact items. For example, an author relationship can be established and utilized to capture a wide class of audio and/or video authors. For example, a respective musician(s), author(s), conductor(s), violinist(s), actor(s), director(s), etc. can be considered an author of a record, and a those listed in movie credits can be considered an author of video, wherein the different types of authors can be distinguished from one another via a role associated with the relationship. Thus, audio or video can have a relationship with a contact item with a role defined as “musician,” another relationship with a different contact item with a role define as “composer,” another relationship with a different contact item with a role define as “conductor,” etc. It is to be appreciated that a contact item can additionally include information about a person such as a phone number, an address, and a link to emails, for example.

As noted above, contact items provide for efficient querying across data. For example, employing a contact item provides for a query(s) across disparate data to obtain a list of credits for a movie/record. In anther example, the query(s) can be performed across data for all works associated with a particular artist (e.g., utilize the artist's contact item and enumerate all author relationships to it). Such querying can return songs authored by the artist, songs that the artist performed on, books authored and/or about the artist, movies where the artist performed, etc. It is to be appreciated that relationships to the contact items enable such functionality and that the audio and/or video data may not include such information. This benefit can be exploited with home videos wherein the director and actor of the video can be a relatives and/or friends.

The file management component 110 can additionally locate, provide and associate suggested metadata with a file, wherein the suggested metadata can include a level of confidence that indicates a degree of confidence that such metadata is actually associated with the file. For example, when an audio track is received, the file management component 110 can establish relationships with suggested metadata with various levels of confidence. For example, the file management component 110 can obtain (e.g., via a local and/or remote source) record metadata determined to be associated with the source of the track based on a confidence and provide the metadata along with the confidence. In one aspect of the present invention, an algorithm can be employed to locate and obtain the metadata for a track. A user and/or intelligence employed in connection with system 100 can select suitable metadata from the suggested data, wherein any or all suggested and/or selected metadata can be stored with the record. In another example, a user requesting or listening to a track can be notified of other media related the track. For example, the user can be notified that a special regarding an artist performing on the track is scheduled to air on television.

It is noted that metadata can be associated with a lifecycle via various fields that capture states that correspond to different steps and/or stages in retrieving and/or computing metadata. For example, metadata can be associated with a field that tracks the number of times retrieval of metadata is unsuccessfully attempted. Such information can be utilized to mitigate repeated attempts to retrieve metadata. For example, a threshold number of attempts can be defined, wherein once the threshold is reached, retrieval attempts can be halted unless and/or until an override signal is received. In another example, metadata can be associated with a field that defines constraints relating to resources utilized to retrieve metadata (e.g., network connectivity) and a priority that determines how rapidly metadata can be obtained.

The file management component 110 can additionally facilitate resolving associations between an audio record and its source album. In general, an audio record typically includes at least some information (e.g., name, title, author, etc.) regarding its source album. However, in many instances this information, although legitimate, can incorrect and/or vary between audio records from the same source. For example, the information can be misspelled, misinterpreted and/or altered. The file management component 110 can retrieve the actual album information (e.g., name, title, author, etc.) to resolve any conflicts and store both the original, or perceived information (from the audio record) and the actual information (from the album) with the audio record. For example, the original information can be included within the properties of the relationship associated with the album. It is noted that the original information remains with an audio track (e.g., when it is copied or moved), whereas that actual information is obtained and utilized to resolve any discrepancies.

The file management component 110 can additionally associate ratings with files. In general, a rating can be associated with an authority (e.g., MPAA, RIAA, TV, user, etc.), based on the type of file (e.g., movie, audio track, etc.) and reflect various scales (e.g., parental, quality, user, etc.). Such ratings can be utilized across various kinds of files. For example, the rating can be utilized to query for a user's “favorites” or to restrict the content (e.g., audio, video, book, picture, etc.) provided to a user based on the user.

The file management component 110 can additionally maintain a file history. The file history can include information regarding whether a file was edited, how a file was edited, when a file was edited, was the file emailed, who the file was emailed to, etc. Such history can be utilized in connection with an algorithm to render intelligent decision-making. For example, the history can be retrieved and employed to automatically construct a “favorites” list based on the number of time a file is accessed and to automatically execute files on a particular day and time and in a particular order. Determining that a user invested a lot of time editing a file can indicate that the file is important to the user and should not be deleted.

The file management component 110 can name and store additional information regarding sub-parts of video. Such capability can be utilized, for example, to indicate a favorite part of a movie. For example, the sub-part can be named “my favorite part” and include a description such as “the part where . . . ” In another example, a part of the movie that is representative of the movie content can be identified. The sub-parts can be employed to quickly play the corresponding movie parts. For example, a request can be made to play only those parts of the movie that include a particular actor.

It is to be appreciated that the foregoing is illustrative and not limitative. Those skilled in the art will understand and appreciate that various other file management capabilities, including the novel aspects described below, can be performed in connection with system 100.

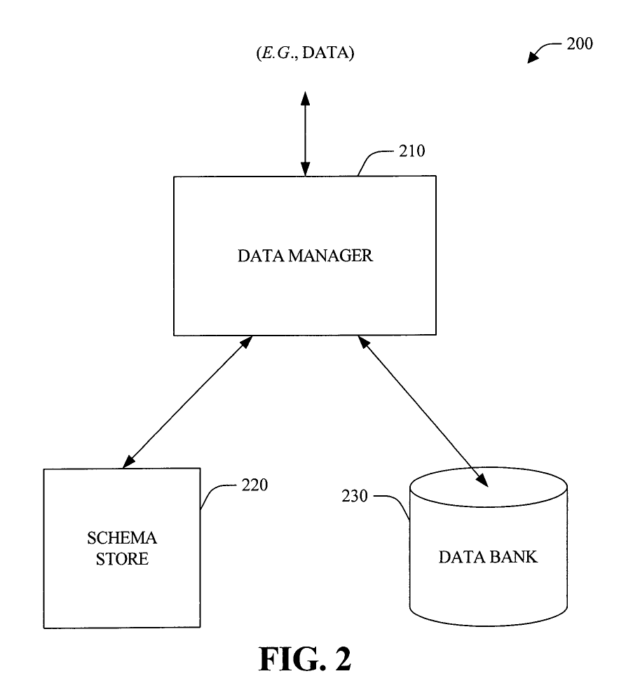

FIG. 2 illustrates a file system 200, in accordance with an aspect of the present invention. The file system 200 comprises a data manager 210 that can receive input that is stored within a data bank 220. The input can be virtually any type of electronic data including, but not limited to, audio and/or video data. Examples of suitable audio data include ripped audio files from CD, audio files generated from audio recorders, audio recorded via audio hardware (e.g., sound card), analog audio from an album and/or a tape (e.g., cassette, 8-track, reel-to-reel, etc.), audio files from memory (e.g., memory stick and other portable memory), audio files downloaded (e.g., via the Internet), and the like. Examples of suitable video data include data from DVDs, video CDs (VCDs), camcorders, digital camcorder, digital camera, and the like. Other data can include images, documents, etc.

The data manager 210 can obtain a schema (e.g., the media, video and audio schema described in detail below) associated with the input from a schema store 230. For example, for audio input, the data manager 210 can retrieve a schema related to audio data from the schema store 230. Such schema can be a common, or base schema that can represent virtually any known type of input (e.g., a document, audio and video). In another example, the retrieved schema can be a derivation of a common schema that is customized and/or enhanced based on at least one characteristic (e.g., property) associated with the input. Such a derivation can include overloads and/or extensions to the base schema. In yet another example, the schema can be tailored to the data type.

The data manager 210 can utilize the rich schema to facilitate systematic storage and organization of the input within the data bank 220. Employing common schema and/or schema derived from a base schema provides for storage of disparate data (e.g., video, audio, documents, etc.) within a similar storage medium, wherein the data manager 210 can seamlessly identify, differentiate and access respective disparate data. In addition, associations can be formed across the disparate data. Such capabilities provide for an improvement over conventional file systems, which typically do not contemplate the structure of data within files; and thus, a file commonly is only accessible to the application that generated the file.

The data manger 210 can further receive input related to a request for data stored within a data bank 220. For example, a user can execute an audio player and select an audio track(s), or file(s) to play back. The data manager 210 can utilize the schema associated with the audio track(s) to locate and provide access to selected track(s). Likewise, video and other data stored within the data bank 220 can be accessed via the data manager 210 through schema associated with such data.

It is to be appreciated that the file system 200 can be employed in connection with an operating system. Such an operating system would allow third party vendors to focus application development on generating rich front-ends for multi-media applications that improve user experience rather than constructing proprietary schemas that typically cannot be shared across vendors and on interfacing applications with the operating system. Thus, the novel aspects of the invention provide for an extensible platform that can be utilized as a foundation for vendors to generate arbitrary applications that employ disparate data.

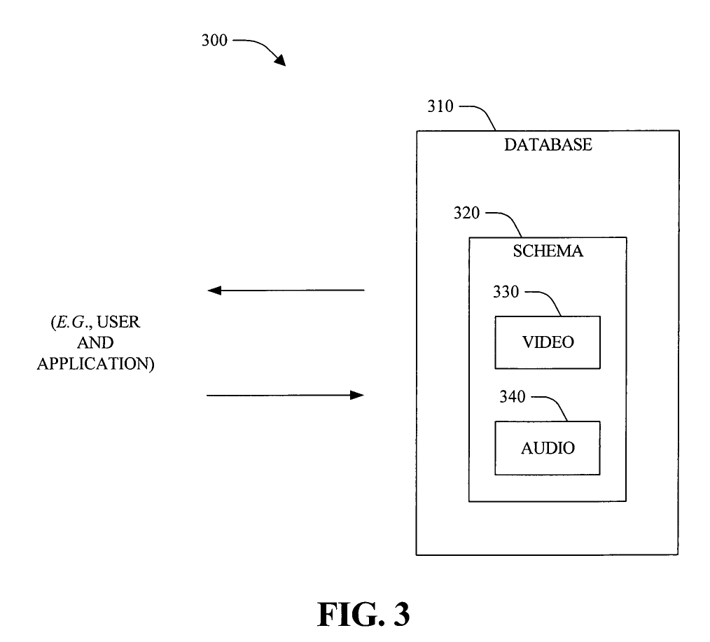

FIG. 3 illustrates a system 300 that manages data, in accordance with an aspect of the present invention. The system 300 comprises a database 310 associated with a schema 320 that includes at least a video schema 330 and an audio schema 340. A user and/or application can interact with the database 310 in order to store and/or organize data, query and/or manipulate (e.g., edit, move and delete) data in the database 310, wherein the data can include disparate audio and/or video information, for example.

The schema 320 typically is a base, or generic schema that can represent any media, and the video schema 330 and audio schema 340 typically are extensions of the schema 320 that can include domain-specific properties for video and audio data, respectively. It is noted that in one aspect of the invention the video schema 330 and audio schema 340 can be based on the generic schema 320 and that other schemas (not shown) can additionally be provided. Such schemas can be utilized in connection with a central file system, or file management system (e.g., in connection with an operating system), wherein virtually any and all files can be stored based on a respective schema and/or derivations thereof, including the video schema 330 and the audio schema 340.

In general, when a user and/or application conveys data to the database 310 that is to be stored in the database 310, a suitable schema can be obtained. For example, when audio data such as a track or group of tracks is transmitted to the database 310 for storage, the schema 320 or the audio schema 340 can be retrieved and utilized to facilitate storing the audio data in a structured manner. In addition, the user and/or application can utilize the schema when manipulating such saved data. For example, if the user and/or application attempts to edit, delete, move, etc. the stored audio data, the schema 320 and/or audio schema 340 can be retrieved and utilized to facilitate such manipulation. Furthermore, the schema can be retrieved and utilized to facilitate servicing a query from the user and/or application, for example, facilitating returning a music track for playback.

It is to be appreciated that suitable applications can include any known audio and/or video application such as various media players, audio players and video players, for example. In addition, more than one application can concurrently employ a schema (e.g., base schema 320, video schema 330 and audio schema 340), which can provide for improved efficiency and performance. It is to be understood that the more than one application can be executed via one or more users from one or more systems.

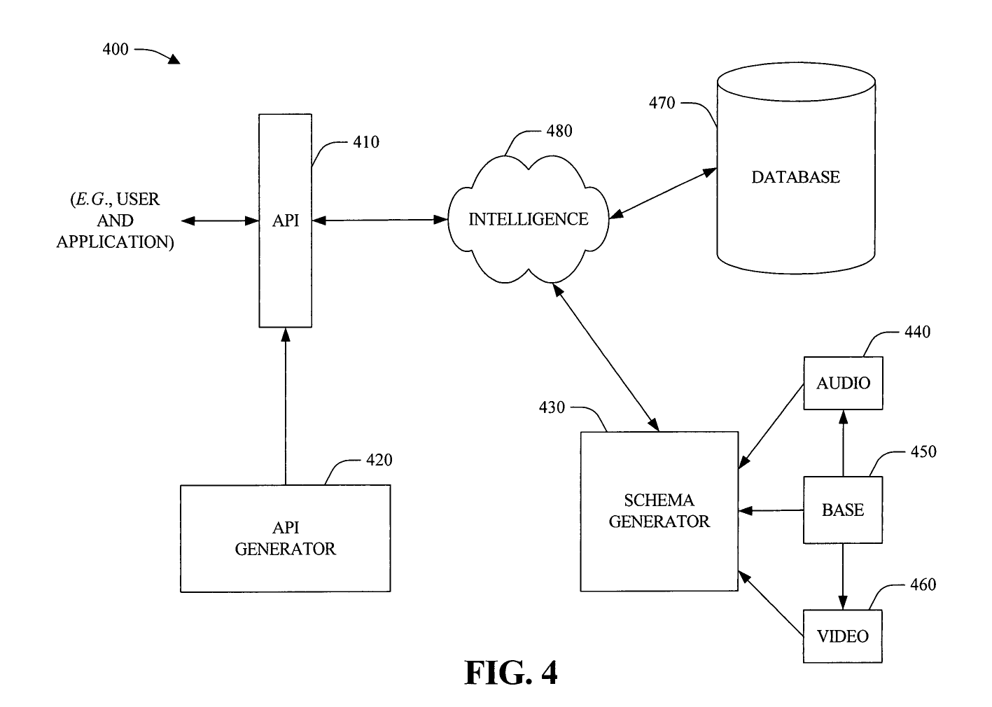

FIG. 4 illustrates a system 400 that can be utilized to systematically store and access information, in accordance with an aspect of the present invention. The system 400 comprises an application program interface (API) 410 that can be utilized by a user and/or application to interact with the system 400. In one aspect of the present invention, the system 400 can include an API generator 420 that can create various APIs based on one or more schemas. For example, the API generator 420 can create an audio API based on an audio schema created by the schema generator 430. The schema generator 430 can create such a schema via the audio configuration 440 and/or base (e.g., a media) configuration 450.

In another example, the API generator 420 can create a video API based on a video and/or generic schema that can be based on the base configuration 450 and/or a video configuration 460. In yet another example, the API generator 420 can create a common (e.g., media) API that can be utilized with virtually any type of data. The user and/or application can employ such APIs to transmit/receive information to/from the database 470. For example, the user and/or application can employ a suitable API to store and/or retrieve audio and/or video data from the database 470.

It is to be understood that the more than one application can be executed via one or more users from one or more systems. Thus, essentially any user and/or application can communicate with the database 470 via the API 410.

The intelligence component 480 can be employed to facilitate storage and retrieval of data, schema generation and API generation, as well as various other utilities such as automating actions and rendering decisions. For example, the intelligence component 480 can facilitate associating a track with a title. For example, a user can store several tracks to the database 470, wherein more than one track can originate from a similar source but include a variation of source's title. For example, a user may misspell the title name after ripping a track. The intelligence component 480 can facilitate resolving such issues. For example, in one aspect of the present invention, the intelligence component can obtain and/or infer likely variations and utilize such variations to facilitate resolving an issue. In another aspect of the present invention, the intelligence component 480 can prompt the user and/or application for further information. Moreover, the intelligence component 480 can employ statistics, probabilities, classifiers and inferences.

The user and/or application can define a setting, which can determine the amount (e.g., none to full) of automation and decision-making by the intelligence component 480. In addition, the intelligence component 480 can utilize historical information to self-define the amount of automation and decision-making. For example, the intelligence component 480 can employ a number of times the user and/or application has rejected particular action and/or decision rendered by the intelligence component 480, wherein a number greater than a threshold value can indicate that the intelligence component 480 should not employ full automation. In another aspect of the invention, the user and/or application can provide training sets to the intelligence component 480 so that the intelligence component 480 can learn from the training sets.

In general, intelligence component 480 inferences refer to the process of reasoning about or inferring states of the system, environment, and/or user from a set of observations as captured via events and/or data. In addition, inferences can be employed to identify a specific context or action, or can generate a probability distribution over states, for example. Furthermore, the inference can be probabilistic, for example, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.) can be employed in connection with performing automatic and/or inferred action in connection with the subject invention.

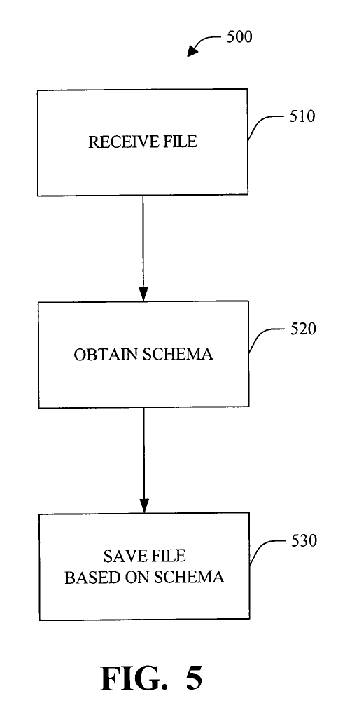

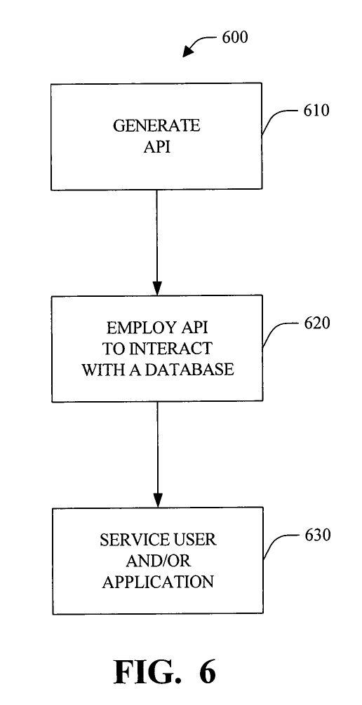

FIGS. 5 and 6 illustrate methodologies, in accordance with an aspect the present invention. While, for purposes of simplicity of explanation, the methodologies are shown and described as a series of acts, it is to be understood and appreciated that the present invention is not limited by the order of acts, as some acts can, in accordance with the present invention, occur in different orders and/or concurrently with other acts from that shown and described herein. For example, those skilled in the art will understand and appreciate that the methodologies could alternatively be represented as a series of interrelated states or events, such as in a state diagram. Moreover, not all illustrated acts may be required to implement the methodologies in accordance with the present invention.

FIG. 5 illustrates a methodology 500 that employs a rich schema set in connection with a file management system, in accordance with an aspect of the present invention. Proceeding to reference numeral 510, a file is received. In one aspect of the present invention, the received file can include audio and/or video data and can be conveyed by a user, an application or a user through an application, for example.

At reference numeral 520, a schema associated with the file is retrieved. For example, a common schema that can represent virtually any known type of file can be retrieved. In another example, the schema retrieved can correspond to the format of the file. For example, the schema can be an audio-based schema utilized to facilitate storing audio files or a video-based schema utilized to facilitate storing video files. It is to be appreciated that such format-based schema can be derived from the common schema and can be utilized to customize and/or enhance the common schema based on the file format.

After retrieving a suitable schema, at 530 the schema can be employed to store the file within the database. Typically, the schema provides for systematically arranging the file with respect to other information within the database. It is to be appreciated that such schema, along with other schemas, can be utilized in connection with a file system, for example, in association with an operating system, wherein virtually any and/or all files can be stored based on the schema and/or derivations thereof.

FIG. 6 illustrates a methodology 600 that facilitates file management within a database, in accordance with an aspect of the present invention. At reference numeral 610, an API is generated that facilitates the interaction between a user and/or application and the database. The API can be employed to store, manipulate, retrieve and/or remove files from the database. The API utilized can be file independent or dependent. An independent API, for example, can be utilized with virtually any type of file, whereas a dependent API typically is generated based on a file format and subsequently employed when communicating a file with such format. For example, an audio file based API can be utilized to convey audio file and a video file based API can be utilized to convey video files.

At 620, the user and/or application can invoke the API. For example, when the user/application desires to store an audio file, the user/application can employ the common or audio-based API to convey the file to the database. In another example, the user/application can transmit a request to manipulate a stored file. For example, the user can request to change the file name, location, type, protection, etc. In yet another example, the user/application can request the file to be removed, or deleted from the database. In still another example, the user/application can query the database to retrieve a file.

At 630, the database can obtain an associated common and/or extended (e.g., audio-based) schema to facilitate servicing the user/application. For example, the schema can be employed to facilitate schematically storing the file within the database. In another example, the schema can be utilized to define the scope of any manipulation of the file. In yet another example, the schema can determine how and if the file can be removed. In still another example, the schema can be employed in connection with searching the database for the file. Such schema can be a generic schema that can represent any media and optionally include extensions that can include domain-specific properties, for example, video and audio data.

When fulfilling the user/application's request, the API can be employed by the database to notify the user/application. For example, the database can transmit acknowledgments or an error code. In addition the database can utilize the API to return a file to the user/application. It is to be appreciated that suitable applications can include any known application (e.g., media players, audio players and video players), wherein one or more application can concurrently employ a schema. Furthermore, one or more applications can be executed via one or more users from one or more systems.

### Schema

The following sections describe exemplary media, video and audio schema that can be employed in accordance with an aspect of the present invention (e.g., in connection with the systems 100-400 and methods 500-600). It is to be appreciated that the media schema can be derived from a Core schema (e.g., System.Storage.Core.Document) and that the video and/or audio schema can be derived from the Media schema (e.g., System.Storage.Media.Document) and/or an Item (e.g., System.Storage.Item) schema. In addition, such schema can be employed in connection with any known kind of data, for example, documents, images, photos and the like.

### Media Schema

The media schema utilizes the following schema: System.Storage and System.Storage.Core. In addition, the media schema comprises item types, extension types, relationship types, nested types. The foregoing types are described in detail below.

Item Types

The following table provides an exemplary Document type. In general, this type can represent an audio document such as a tracks, an albums, etc. It typically includes one or more fields that are common to documents. It can be derived from System.Storage.Core.Document.

| | | | | Change | Content |
|---|---|---|---|---|---|
| Property Name | Type | Nullable | Default | Unit | Indexed |
| ContentGroup | System.Storage.String (64) | true | | | False |
| Description | ContentGroupDescription describes the larger group of sounds/music the | | | | |
| | content belongs to (e.g. “Piano Concerto”, or “Musical Work” for music stuff). | | | | |
| Duration | System.Storage.Int64 | true | | | False |
| | Duration is the duration of the track in milliseconds. | | | | |
| RecordingDate | System.Storage.DateTime | true | | | False |
| | The date when the media document was recorded. If the time portion is set to | | | | |
| | 00:00 on Jan/1 UI will ignore the time portion of the value (e.g. it becomes a | | | | |
| | date field). | | | | |
| ReleaseDate | System.Storage.DateTime | true | | | False |
| | The date when the media document was released. If the time portion is set to | | | | |
| | 00:00 on Jan/1 UI will ignore the time portion of the value (e.g. it becomes a | | | | |
| | date field). | | | | |
| Genre | MultiSet< | true | | | False |
| | System.Storage.Media.MVString256 > | | | | |
| | Genre refers to the kind of music (e.g. Rock; Pop; Pop: Top10 etc.) | | | | |
| StyleByMetadata | MultiSet< | true | | | False |
| Provider | System.Storage.Media.MVString256 > | | | | |
| | Style (Genre) from the original provider of metadata (e.g. AMG could give | | | | |
| | “Rock”). | | | | |
| Mood | MultiSet< | true | | | False |
| | System.Storage.Media.MVString256 > | | | | |
| | Mood is one of a limited set of possibilities like “ambient”, “energetic”, etc. | | | | |
| Period | System.Storage.String (128) | true | | | False |
| | Period refers to time period/style associated with the music (e.g. “Baroque”). | | | | |
| Rating | MultiSet< | true | | | False |
| | System.Storage.Media.Rating > | | | | |
| | An audio record may be rated by different agencies for quality, parental | | | | |
| | advisory, etc. This multivalued field contains all such ratings for a given | | | | |
| | document. Examples of ratings to be included are: Parental, Quality, | | | | |
| | UserCommunity, Provider, etc. | | | | |
| RelevantUrl | MultiSet< | true | | | False |
| | System.Storage.Media.UrlReference > | | | | |
| | Represents Urls relevant to this document. | | | | |
| MetadataProvider | System.Storage.String (256) | true | | | False |
| Copyright | Copyright for metadata fields provided by the provider. (e.g. PressPlay) | | | | |
| MetadataProvider | System.Storage.String (128) | true | | | False |
| Name | ProviderName specifies the original provider of metadata (e.g. AMG). | | | | |
| OriginalPhysicalID | System.Storage.String (1024) | true | | | False |
| | OriginalPhysicalID (a.k.a. TOC) is an album identifier obtained by | | | | |
| | concatenating durations of tracks in the album. | | | | |
| Protected | System.Storage.Boolean | true | | | False |
| | Protected is true if track content is protected. | | | | |
| ProtectedType | System.Storage.String (128) | true | | | False |
| | ProtectedType specifies the kind of media protection (Microsoft DRM, | | | | |
| | certificates or Sony DRM). | | | | |
| History | MultiSet< | true | | | False |
| | System.Storage.Media.History > | | | | |
| | The history of this media document. Which filters did I apply to it? Whom did I | | | | |
| | mail it to? When did I print it? | | | | |
| MediaClass | System.Storage.Guid | true | | | False |
| PrimaryID | MediaClassPrimaryID (e.g. audio/video/playlist) identifies class of media. | | | | |
| MediaClass | System.Storage.Guid | true | | | False |
| SecondaryID | MediaClassSecondaryID (e.g. smart/regular playlist) identifies class of media. | | | | |
| NoAutoInfo | System.Storage.Boolean | true | | | False |

| | |
|---|---|
| Processing | Boolean that says “don't update me automatically, ever”. Can apply to audio |
| | and video files. (and photos). |

Extension Types

The following table provides exemplary MetadataLifecycle type. In general, this type can represent lifecycle and other state tracking. It can be derived from System.Storage.Extension.

| | | | | Change | Content |
|---|---|---|---|---|---|
| Property Name | Type | Nullable | Default | Unit | Indexed |
| Constraints | System.Storage.Int32 | true | 0 | | False |
| | Type of resource the lifecycle is awaiting in order to make its next state | | | | |
| | transition. | | | | |
| MatchState | System.Storage.Int32 | true | 0 | | False |
| | Match state as determined after we attempt to get metadata and either | | | | |
| | succeed or fail. This governs all further processing. | | | | |
| Priority | System.Storage.Int32 | true | 0 | | False |
| | Original priority as defined by caller. | | | | |
| RetryCount | System.Storage.Int32 | true | 0 | | False |
| | Number of times we've retried lifecycle after a failure. | | | | |
| State | System.Storage.Int32 | true | 0 | | False |
| | State variable indicating in which part of lifecycle this tracks currently resides. | | | | |
| SubState | System.Storage.Int32 | true | 0 | | False |

SubState variable indicating in which part of lifecycle this tracks currently
resides.

Relationship Types

The following table provides exemplary ContentDistributor type. In general, this type refers to the distributor of the content (e.g., PressPlay). It can be derived from System.Storage.Relationship. Its source type is System.Storage.Media.Document and its target type is System.Storage.Core.Contact.

| Property | | | | Change | Content |
|---|---|---|---|---|---|
| Name | Type | Nullable | Default | Unit | Indexed |
| Data | System.Storage.Media.ContentDistributorData | true | | | False |

ContentDistributor Data.

The EffectiveBackCoverArt type can represent a link to a picture of the back cover of a media document. It can be derived from System.Storage.Relationship. Its source type is System.Storage.Media.Document and its target type is System.Storage.Core.Document.

The EffectiveFrontCoverArt type can represent a link to a picture of the front cover of a media document. It can be derived from System.Storage.Relationship. Its source type is System.Storage.Media.Document and its target type is System.Storage.Core.Document.

The MetadataProviderLogo type can represents a logo associated with an original provide of metadata (e.g., AMG). In addition to the foregoing, the tables below provide exemplary types that can be employed in accordance with an aspect of the present invention. It can be derived from System.Storage.Relationship. Its source type is System.Storage.Media.Document and its target type is System.Storage.Core.Document.

Nested Types

The following table provides exemplary ContentDistributorData type. In general, this type can represents a link to a Contact item for Content Distributor for Media information. It can be derived from System.Storage.Relationship. It can be derived from System.Storage.NestedType.

| | | | | Change | Content |
|---|---|---|---|---|---|
| Property Name | Type | Nullable | Default | Unit | Indexed |
| DisplayName | System.Storage.String (64) | true | | | False |
| | Display Name of the distributor. | | | | |
| SubscriptionContentID | System.Storage.String (128) | true | | | False |

Subscription Content ID for the distributor.

The following table provides exemplary History type. In general, this type can represent a history of a media document (e.g., when it was edited, how it was edited, who was it mailed to, was it rotated, was a filtered applied, an associated play count, etc.). It can be derived from System.Storage.NestedType.

| | | | | Change | Content |
|---|---|---|---|---|---|
| Property Name | Type | Nullable | Default | Unit | Indexed |
| Date | System.Storage.DateTime | true | | | False |
| | The date when this operation has been performed. | | | | |
| Name | System.Storage.String (128) | true | | | False |
| | The name of operation applied. Can be the name of filter for the “Process” type | | | | |
| | operation, “Email” for “Share” type, “Print” for “View” type, etc. | | | | |
| Provider | System.Storage.String (128) | true | | | False |
| | The name of an application that provided this history record. Example: | | | | |
| | “MediaPlayer”. | | | | |
| Type | System.Storage.String (64) | false | | | False |
| | The type of operation performed on this document (enum type). values can be: | | | | |
| | “Acquisition”, “View”, “Share”, “Process” | | | | |
| Value | System.Storage.String (128) | true | | | true |

One value per operation that is used by this operation. If operation is email this
will be the email address where it was emailed. if an operation is rotate this will
the the degrees rotated by. Would be nice to replace this with name-value pairs
to represent parameters if WinFS ends up supporting this.

The following table provides exemplary Rating type. In general, this type can represent a rating given to a media document by authority. For example, such authority can include MPAA ratings for video (e.g., PG-13, NR, R, X and NC-17), RIAA ratings for audio (e.g., explicit lyrics), TV ratings and/or user custom rating. In addition, ratings can be delineated by parental, quality, user custom, etc. Typically, there are two types of ratings: string rating and numeric rating. In general, this type is an abstract type and can be derived from System.Storage.NestedType.

| | | | | Change | Content |
|---|---|---|---|---|---|
| Property Name | Type | Nullable | Default | Unit | Indexed |
| RatingProvider | System.Storage.String (64) | false | | | False |
| | The name of an authority issuing the rating. Example: “Microsoft”, “User”, | | | | |
| | “MSN Community”, “CDDB”, etc. | | | | |
| Type | System.Storage.String (64) | false | | | False |

The type of rating. Could be “Parental”, “Star”, “Quality”, etc.

The following table provides exemplary CustomRating type. In general, this type can represent a free-form string rating given to the media document by some authority. It can be derived from the abstract type System.Storage.Media.Rating, which is described above.

| | | | | Change | Content |
|---|---|---|---|---|---|
| Property Name | Type | Nullable | Default | Unit | Indexed |
| Value | System.Storage.String (128) | false | | | False |

The value of the rating. Example: “PG-13”.

The following table provides exemplary StarRating type. In general, this type can represent a numeric rating given to the media document by some authority. It can be derived from the abstract type System.Storage.Media.Rating, which is described above.

| | | | | Change | Content |
|---|---|---|---|---|---|
| Property Name | Type | Nullable | Default | Unit | Indexed |
| Value | System.Storage.Int32 | false | | | False |

The value of the rating in percents. 0 star is 0%, 1 star is 1%, 2 stars in 25%, 3
stars is 50%, 4 stars is 75%, 5 stars is 100%.

The following table provides exemplary URLReference type. In general, this type can represent a URL and a category indicating the type URL. It can be derived from System. Storage.NestedType.

| Property | | | | Change | Content |
|---|---|---|---|---|---|
| Name | Type | Nullable | Default | Unit | Indexed |
| UrlString | System.Storage.String (max) | true | | | False |
| | UrlString contains the URL itself. For example: “http://www.microsoft.com” | | | | |
| UrlType | MultiSet< | true | | | False |
| | System.Storage.Media.MVString128 > | | | | |

The category of the URL. The category is user-defined and can be “HomePage”,
“Promotion”, “UserWeb”, “Provider”, “Source”, etc.

The following table provides exemplary MVString128 type. In general, this type can represent a multi-valued string wrapper. It can be derived from System.Storage.NestedType.

| | | | | Change | Content |
|---|---|---|---|---|---|
| Property Name | Type | Nullable | Default | Unit | Indexed |
| Data | System.Storage.String (128) | false | | | False |

String

The following table provides exemplary MVString256 type. In general, this type can represent a multi-valued string wrapper. It can be derived from System.Storage.NestedType.

| | | | | Change | Content |
|---|---|---|---|---|---|
| Property Name | Type | Nullable | Default | Unit | Indexed |
| Data | System.Storage.String (256) | false | | | False |

String

### Video Schema

The video schema utilizes the following schema: System.Storage; System.Storage.Media, and System.Storage.Core. In addition, the media schema comprises item types, extension types, relationship types, nested types. The foregoing types are described in detail below.

Item Types

The following table provides an exemplary VideoRecord type. In general, this type can represent a video recording. It can be derived from System.Storage.Media.Document.

| | | | | Change | Content |
|---|---|---|---|---|---|
| Property Name | Type | Nullable | Default | Unit | Indexed |
| BitRate | System.Storage.Int32 | true | | | False |
| | The BitRate - bandwidth required to stream this file. BitRate for variable | | | | |
| | Boolean rate files is the average Boolean rate. | | | | |
| CameraModel | System.Storage.String (64) | true | | | False |
| | The model name of the camera used to take the picture. | | | | |
| DateTakenEnd | System.Storage.DateTime | true | | | False |
| | The date when the video shooting ended. | | | | |
| DateTakenStart | System.Storage.DateTime | true | | | False |
| | The date when the video shooting started. | | | | |
| FrameRate | System.Storage.Int32 | true | | | False |
| | The number of frames per second. This only refers to the main portion of | | | | |
| | the video. For example FBI warning may have a different Frame Rate. | | | | |
| AspectRatioHorizontal | System.Storage.Int32 | true | | | False |
| | The aspect ratio of individual pixel. This only refers to the main portion of | | | | |
| | the video. For example FBI warning may have a different Aspect Ratio. | | | | |
| AspectRatioVertical | System.Storage.Int32 | true | | | False |
| | The aspect ratio of individual pixel. This only refers to the main portion of | | | | |
| | the video. For example FBI warning may have a different Aspect Ratio. | | | | |
| SizeX | System.Storage.Int32 | true | | | False |
| | The number of pixels in the horizontal direction of the picture. This only | | | | |
| | refers to the main portion of the video. For example FBI warning may | | | | |
| | have a different SizeX. | | | | |
| SizeY | System.Storage.Int32 | true | | | False |
| | The number of pixels in the vertical direction of the picture. This only | | | | |
| | refers to the main portion of the video. For example FBI warning may | | | | |
| | have a different SizeY. | | | | |
| Summary | System.Storage.String (4000) | true | | | False |
| | A short description of the Video. | | | | |
| Sequence | System.Storage.Int32 | true | 0 | | False |

Sequence number for DVD titles and chapters.

The following table provides an exemplary RecordedTV type. It can be derived from System.Storage.Video.VideoRecord.

| | | | | Change | Content |
|---|---|---|---|---|---|
| Property Name | Type | Nullable | Default | Unit | Indexed |
| ChannelNumber | System.Storage.Int32 | true | | | False |
| | TV channel from which the program was recorded. | | | | |
| ClosedCaptioning | System.Storage.Boolean | true | | | False |
| | Is closed captioning available? | | | | |
| Credits | System.Storage.String(max) | true | | | False |
| | Credits | | | | |
| EpisodeTitle | System.Storage.String (128) | true | | | False |
| | We should use Subtitle for this. EHome application? | | | | |
| Repeat | System.Storage.Boolean | true | | | False |
| | Is it a repeat? | | | | |
| Sap | System.Storaqe.Boolean | true | | | False |
| | Is SAP available? | | | | |
| StationName | System.Storage.String (32) | true | | | False |
| StationCallSign | System.Storage.String (32) | true | | | False |
| | Local TV station name e.g.: KOMO4. | | | | |
| NetworkAffiliation | System.Storage.String (32) | true | | | False |
| | Example: NBC. | | | | |
| VideoQuality | System.Storage.String (32) | true | | | False |
| | Video quality | | | | |
| AudioQuality | System.Storage.String (32) | true | | | False |
| | Audio quality. | | | | |
| RecordingRequestId | System.Storage.Guid | true | | | False |
| | ID used by Media Center to know which show it is. | | | | |
| EncodingToolName | System.Storage.String (128) | true | | | False |
| | Encoding tool name. | | | | |
| EncodingToolVersion | System.Storage.String (32) | true | | | False |
| | Encoding tool version. | | | | |
| ServiceId | System.Storage.String (32) | true | | | False |
| OriginalBroadcastDateTime | System.Storage.DateTime | true | | | False |
| | Time of original broadcast. | | | | |
| IsPremiere | System.Storaqe.Boolean | true | | | False |
| | Boolean if this recording represents the premiere run of this TV show | | | | |
| | (typically a movie). | | | | |
| IsFinale | System.Storage.Boolean | true | | | False |
| | Boolean if this recording represents the Finale of this TV show. | | | | |
| IsSubtitled | System.Storage.Boolean | true | | | False |
| | Boolean if this recording has subtitles. | | | | |
| IsLive | System.Storage.Boolean | true | | | False |
| | Boolean if this recording was live at the time of airing. | | | | |
| IsTapeDelay | System.Storage.Boolean | true | | | False |

Boolean if this recording was tape delayed at the time of airing.

The following table provides exemplary VideoClip type. In general, this type can represent a video clip. It can be derived from System.Storage.Item.

| | | | | Change | Content |
|---|---|---|---|---|---|
| Property Name | Type | Nullable | Default | Unit | Indexed |
| AudioClassification | System.Storage.Int32 | true | | | False |
| | index for audio type (MSRA) -- UNKNOWN, SPEECH, MUSIC, SILENCE, | | | | |
| | BACKGROUND NOISE (MSRA) | | | | |
| AudioEnergy | System.Storage.Int32 | true | | | False |
| | average energy in clip (MSRA) | | | | |
| DateTakenEnd | System.Storage.DateTime | true | | | False |
| | Denotes date/time range that video clip covers | | | | |
| DateTakenStart | System.Storage.DateTime | true | | | False |
| | Denotes date/time range that video clip covers | | | | |
| MotionType | System.Storage.Int32 | true | | | False |
| | index for motion type (MSRA) -- PAN (8 directions), ZOOM (in/out), STILL, | | | | |
| | SHAKE, ROTATE (cw/ccw) (MSRA) | | | | |
| OverallQuality | System.Storage.Int32 | true | | | False |
| | single score for quality (MSRA) | | | | |
| AspectRatioHorizontal | System.Storage.Int32 | true | | | False |
| | e.g. 16:9, 4:3, 14:9, Mixed, etc. | | | | |
| AspectRatioVertical | System.Storage.Int32 | true | | | False |
| | e.g. 16:9, 4:3, 14:9, Mixed, etc. | | | | |
| Rating | MultiSet< | true | | | False |
| | System.Storage.Media.Rating > | | | | |
| | A VideoClip may be rated by different agencies for quality, parental advisory, | | | | |
| | etc. This multivalued field contains all such ratings for a given document. | | | | |
| | Examples of ratings to be included are: Parental, Quality, UserCommunity, | | | | |
| | Provider, etc. | | | | |
| SignalFormat | System.Storage.Int32 | true | | | False |
| | Input Video Signal Type (interlaced motion picture, non-interlaced motion | | | | |
| | picture, frame still picture, field still picture, mixed) | | | | |
| SourceEndTime | System.Storage.Int64 | false | | | False |
| | out, relative to source (milliseconds) | | | | |
| SourceStartTime | System.Storage.Int64 | false | | | False |
| | in, relative to source (milliseconds) | | | | |
| Title | System.Storage.String (128) | true | | | False |
| | based on source file by default | | | | |
| MotionIntensity | System.Storage.Double | true | | | False |
| | Average motion intensity for the clip. | | | | |
| SubShots | MultiSet< | true | | | False |
| | System.Storage.Video.VideoSubShot > | | | | |

Sub Shots.

Relationship Types

The Clips type can refer to a set of clips for a video record. It can be derived from System.Storage.Relationship. Its source type is System.Storage.Video.VideoRecord and its target type is System.Storage.Video.VideoClip.

Nested Types

The following table provides exemplary VideoSubShot type. In general, this type can represent a subshot for a video record. It can be derived from System.Storage.NestedType.

| | | | | Change | Content |
|---|---|---|---|---|---|
| Property Name | Type | Nullable | Default | Unit | Indexed |
| SubShotStartTime | System.Storage.Int32 | true | | | False |
| | Units are milliseconds. | | | | |
| SubShotEndTime | System.Storage.Int32 | true | | | False |
| | Units are milliseconds. | | | | |
| Entropy | System.Storage.Double | true | | | False |
| | Range 0.0-1.0 -- average measure of image quality. | | | | |
| MotionType | System.Storage.Int32 | true | | | False |
| | Primary motion type within the SubShot, an enum with values from 0 to 14. | | | | |
| MotionIntensity | System.Storage.Double | true | | | False |
| | Average motion intensity for the shot. | | | | |
| TotalMotion | System.Storage.Int32 | true | | | False |
| | Total Motion. | | | | |
| MotionCount | System.Storage.Int32 | true | | | False |
| | Motion Count. | | | | |
| MotionSummary | System.Storage.Binary (28) | true | | | False |
| | Motion Summary | | | | |
| MotionDisplacement | System.Storage.Binary (28) | true | | | False |
| | Motion Displacement | | | | |
| SortedIndex | System.Storage.Binary (24) | true | | | False |
| | Sorted index. | | | | |

### Audio Schema

The audio schema utilizes the following schema: System. Storage; System.Storage.Media; System.Storage.Core, and System.Storage.Image. In addition, the media schema comprises item types, extension types, relationship types, nested types. The foregoing types are described in detail below.

Item Types

The following table provides an exemplary CachedAlbum type. In general, this type can represent audio, which can include several tracks. It can be derived from System.Storage.Media.Document.

| | | | | Change | Content |
|---|---|---|---|---|---|
| Property Name | Type | Nullable | Default | Unit | Indexed |
| CollectionGroupID | System.Storage.Guid | true | | | False |
| | CollectionGroupID is the Windows Media Information Service box set identifier | | | | |
| | (when a bunch of albums are sold together as a box set). | | | | |
| CollectionID | System.Storage.Guid | true | | | False |
| | CollectionID is the Windows Media Information Service album identifier. | | | | |
| PartOfSet | System.Storage.String (16) | true | | | False |

PartOfSet indicates album's relation to a box set containing it (e.g. 2 of 5).

The following table provides an exemplary AudioRecord type. In general, this type can represent metadata associated with an audio record. The metadata can include information such as file size, file format, type of compression utilized, and the like. This type can be derived from System.Storage.Media.Document.

| | | | | Change | Content |
|---|---|---|---|---|---|
| Property Name | Type | Nullable | Default | Unit | Indexed |
| Channels | System.Storage.Decimal | true | | | False |
| | Channels is the number of audio channels in the track (e.g. 5.1) | | | | |
| ContentID | System.Storage.Guid | true | | | False |
| | ContentID is the Windows Media Information Service identifier for | | | | |
| | the track's content. | | | | |
| Fingerprint | System.Storage.Binary (2048) | true | | | False |
| | DSPFingerprint is a 64-term array of values that uniquely identifies | | | | |
| | the track's audio properties. | | | | |
| InitialKey | System.Storage.String (128) | true | | | False |
| | The musical key that the song starts from. Example: A♯ Major, C♯ | | | | |
| | Minor, etc. | | | | |
| Lyrics | System.Storage.String (4000) | true | | | False |
| | Lyrics contains the text for the audio record with syncronization | | | | |
| | anchors that connects it to the Audio stream (when available). | | | | |
| MetadataProviderContentID | System.Storage.String (2048) | true | | | False |
| | MetadataProviderContentID (UniqueFileIdentifier) is a unique | | | | |
| | identifier that has been assigned to this track by the Metadata | | | | |
| | Provider | | | | |
| SnippetEnd | System.Storage.Int64 | true | | | False |
| | SnippetStart and SnippetEnd specify start and end for preview. | | | | |
| SnippetStart | System.Storage.Int64 | true | | | False |

SnippetStart and SnippetEnd specify start and end for preview.

The following table provides exemplary Track type. In general, this type can represent an audio track that includes music data. For example, it can correspond to a track that has been ripped from a CD or stored in a file system. It can be derived from System.Storage.Audio.AudioRecord.

| | | | | Change | Content |
|---|---|---|---|---|---|
| Property Name | Type | Nullable | Default | Unit | Indexed |
| AutoDJ | System.Storage.Audio.AutoDJ | true | | | False |
| | DSPAutoDJ is a 20-term array of values that allows us to create | | | | |
| | playlists of similar content. | | | | |
| VolumeAverageLevel | System.Storage.Int32 | true | | | False |
| | PeakValue/AverageLevel is the maximum/average value encountered | | | | |
| | in the track (used for volume normalization). | | | | |
| BeatsPerMinuteAverage | System.Storage.Int32 | true | | | False |
| | Beats per minute for the song. | | | | |
| BeatsPerMinuteAtStart | System.Storage.Int32 | true | | | False |
| | Used for cool transitions, mixes, etc. Need to query on them so as to | | | | |
| | best match two songs. | | | | |
| BeatsPerMinuteAtEnd | System.Storage.Int32 | true | | | False |
| | Used for cool transitions, mixes, etc. Need to query on them so as to | | | | |
| | best match two songs. | | | | |
| BitRate | System.Storage.Int32 | true | | | False |
| | The BitRate - bandwidth required to stream this file. BitRate for variable | | | | |
| | Boolean rate files is the average Boolean rate. The scale is: “128 × | | | | |
| | 1000” (e.g. 128000). | | | | |
| VolumePeakValue | System.Storage.Int32 | true | | | False |
| | PeakValue/AverageLevel is the maximum/average value encountered | | | | |
| | in the track (used for volume normalization). | | | | |
| CodecInfo | System.Storage.String (64) | true | | | False |
| | Codec name and version. Example: “WMA 3.1”. | | | | |
| EncodedBy | System.Storage.String (64) | true | | | False |
| | Person who encoded this track. | | | | |
| EncodingSettings | System.Storage.String (128) | true | | | False |
| | A free form string that he person who encoded this uses to capture the | | | | |
| | parameters of encoding process. See also: Encoding tool name. | | | | |
| EncodingTime | System.Storage.DateTime | true | | | False |
| | Date and time when this track has been encoded. If the time portion is | | | | |
| | set to 00:00 on Jan/1 UI will ignore the time portion of the value (e.g. it | | | | |
| | becomes a date field). | | | | |
| EncodingToolName | System.Storage.String (128) | true | | | False |
| | Encoding tool name. | | | | |
| EncodingToolVersion | System.Storage.String (32) | true | | | False |

Encoding tool version.

The following table provides an exemplary CachedTrack type. In general, this type can represent metadata for a cached audio track. In one aspect of the invention, the CachedTrack type can be employed to facilitate identification of data. For example, a user can insert a CD, wherein one or more possible tracks is automatically stored in the CachedTrack and provided to the user. The user can select a track from the list (or provide a different track) that corresponds to the CD. The other tracks can then be removed from the CachedTrack and the selection can be provided to the Audio.Track or Audio.PlatterTrack. Thus, the CachedTrack can represent a location for temporary storage of potential track information. This type can be derived from System.Storage.Audio.AudioRecord.

| | | | | Change | Content |
|---|---|---|---|---|---|
| Property Name | Type | Nullable | Default | Unit | Indexed |
| DownloadTime | System.Storage.DateTime | true | | | False |

Date and time when this track has been downloaded. If the time portion is set to
00:00 on Jan/1 UI will ignore the time portion of the value (e.g. it becomes a
date field).

The following table provides an exemplary PlatterTrack type. In general, this type can represent metadata for an audio track. Such metadata can be maintained with the data, for example, when a track is ripped from a CD the metadata can be included with the ripped track. In addition, the metadata can be utilized to recognize data. For example, a particular CD may be requested. If the wrong CD is provided, as determine via the metadata, the user can be notified that the wrong CD has been inserted. This type can be derived from System.Storage.Audio.AudioRecord.

| | | | | Change | Content |
|---|---|---|---|---|---|
| Property Name | Type | Nullable | Default | Unit | Indexed |
| Hdcd | System.Storage.Boolean | false | false | | False |
| | Is this track HDCD-enabled? | | | | |
| Enabled | System.Storage.Boolean | false | true | | False |
| | Is this track enabled for playback? | | | | |
| Ripped | System.Storage.Boolean | false | false | | False |

Has this track been ripped on this machine?

The following table provides an exemplary PlayList type. In general, this type can represent an audio playlist. It can be derived from System.Storage.Media.Document.

| | | | | Change | Content |
|---|---|---|---|---|---|
| Property Name | Type | Nullable | Default | Unit | Indexed |
| DetectedBrokenLinks | System.Storage.Boolean | true | | | False |

DetectedBrokenLinks is true if a link to a track is broken.

The following table provides an exemplary RadioStation type. In general, this type can represent a radio station that can provide streams of radio. It can be derived from System.Storage.Item.

| | | | | Change | Content |
|---|---|---|---|---|---|
| Property Name | Type | Nullable | Default | Unit | Indexed |
| StationAbstract | System.Storage.String (2048) | true | | | true |
| | Station description/abstract. Thisis not user-entered, but provided by the radio | | | | |
| | station. Example: “KCRW, a community service of Santa Monica community | | | | |
| | college.” | | | | |
| Featured | System.Storage.Boolean | false | | | False |
| | Is this service featured? This is Windows-specific. | | | | |
| Format | System.Storage.String (128) | true | | | False |
| | Format refers to the kind of radio station. This is close to Genre, but radio | | | | |
| | stations track this concept separately. Also there is only one format for a radio | | | | |
| | station (this is a single-valued field). Examples: Top 40, College, Talk, Adult | | | | |
| | Contemporary, etc. | | | | |
| Genre | MultiSet< | true | | | False |
| | System.Storage.Media.MVString128 > | | | | |
| | Genre refers to the kind of radio station. Examples: Rock, Blues, Jazz, | | | | |
| | Electronic, etc. | | | | |
| IsLocal | System.Storage.Boolean | true | | | False |
| | Flag for local station. | | | | |
| Keywords | MultiSet< | true | | | False |
| | System.Storage.Core.Keyword > | | | | |
| | Keywords for the radio station. One keyword per field. These keywords are | | | | |
| | provided by the station itself. Example: “Alternative Music”, “NPR News” | | | | |
| Language | System.Storage.String (32) | true | | | False |
| | The standard code of the primary language of the radio station. Example: en- | | | | |
| | us. | | | | |
| MetadataProviderName | System.Storage.String (128) | true | | | False |
| | ProviderName specifies the original provider of metadata. Examples: Microsoft, | | | | |
| | Real, MusicMatch, etc. | | | | |
| Name | System.Storage.String (128) | false | | | true |
| | Radio Station Name. Example: “The Mountain” | | | | |
| NameSortOrder | System.Storage.String (128) | false | | | False |
| | NameSortOrder is the sort order of the name of the station (e.g. “The | | | | |
| | Mountain” will have SortOrder “Mountain”). | | | | |
| Rating | MultiSet<System.Storage.Media.Rating > | true | | | False |
| | An rating of this radio station. Can be user ration, popularity rating, quality | | | | |
| | rating, etc. | | | | |
| RelevantUrl | MultiSet< | true | | | False |
| | System.Storage.Media.UrlReference > | | | | |
| | Represents Urls relevant to this Radio station. Station web site, archive, | | | | |
| | contact Url, etc. | | | | |
| ShortName | System.Storage.String (128) | true | | | true |
| | Standard call letters/country-designated unique ID or RDS shortname for | | | | |
| | station. Example: KCRW | | | | |
| StationID | System.Storage.Guid | false | | | False |
| | A unique ID of the radio station. Windows assigns unique ids to all radio | | | | |
| | stations for easy handling within the OS. | | | | |
| StatisticalReliability | System.Storage.Int32 | true | | | False |
| | Rating of reliability. 3 = high; 2 = medium; 1 = low; 0 = inactive. (need to define | | | | |
| | method; subject to dead air during blackouts). This field should be enum. | | | | |
| Tier | System.Storage.Int32 | true | | | False |
| | Tier field reflects level of partnership with Windows. This should be an enum | | | | |
| | field with values 1-4. | | | | |
| TunerPosition | System.Storage.String (32) | true | | | False |
| | Terrestrial Tuning info (country/band appropriate). May only apply to some | | | | |
| | countries. Example: 89.9 | | | | |
| TuningBand | System.Storage.String (16) | true | | | False |
| | AM, FM, Net (others per country). | | | | |
| IsPremium | System.Storage.Boolean | true | | | False |
| | Is Premium station. | | | | |
| PlaybackRestricted | System.Storage.Boolean | true | | | False |
| | if yes, the following must also contain data: PlaybackCountry (same list of | | | | |
| | countries as in the Regional settings control panel). PlaybackZipRange (list of | | | | |
| | numerical or alphanumerical (or combination thereof) zip or postal codes that | | | | |
| | are allowed for playback. We will verify client side that the users zip/postal | | | | |
| | code falls into the respective range). | | | | |
| RequiresUserData | System.Storage.Boolean | true | | | False |

This field is used to pass CZAG data upstream to the station

The following table provides an exemplary RadioStream type. In general, this type can represent a radio stream provided by a radio station. For example, it can be embedded within the RadioStation item. It can be derived from System.Storage.Item.

| | | | | Change | Content |
|---|---|---|---|---|---|
| Property Name | Type | Nullable | Default | Unit | Indexed |
| AudioQuality | System.Storage.Int32 | true | | | False |
| | Audio Quality calculated from Boolean rate, codec. 3 = high; 2 = medium; 1 = low. | | | | |
| | Should be a enum type with these 3 values. | | | | |
| BitRate | System.Storage.Int32 | true | | | False |
| | The BitRate - bandwidth required to stream this. BitRate for variable Boolean | | | | |
| | rate files is the average Boolean rate. | | | | |
| CodecInfo | System.Storage.String (64) | true | | | False |
| | Codec name and version. Example: “WMA 3.1”. | | | | |
| ContentType | System.Storage.String (128) | true | | | False |
| | The type of the content. | | | | |
| ContentUrl | System.Storage.String (2048) | false | | | False |
| | URL to stream's asx/mms/html. Example: | | | | |
| | http://www.kcrw.org/asx/kcrwmusic.asx | | | | |
| Stream ID | System.Storage.Guid | true | | | False |

A unique ID of the stream. Windows assigns unique ids to all radio streams for
easy handling within the OS.

The following table provides an exemplary ListeningHabits type. In general, this type can be associated with a user with respect to a track. For example, this item can be utilized for customizing the music playing experience of a user. It can be a employed on a Per-User—Per-Media data, with ACLs on each record for the “owner”. It can be derived from System.Storage.Item.

| | | | | Change | Content |
|---|---|---|---|---|---|
| Property Name | Type | Nullable | Default | Unit | Indexed |
| UserId | System.Storage.Binary (85) | false | | | False |
| | The SID of the user whose listening habits are captured here. | | | | |
| HourlyCounters | MultiSet< | True | | | False |
| | System.Storage.Audio.PlayCounter > | | | | |
| | 24 Hourly counters for keeping track of the number of times the track was | | | | |
| | played by this user in a given hour of the day. | | | | |
| DailyCounters | MultiSet< | True | | | False |
| | System.Storage.Audio.PlayCounter > | | | | |
| | 7 daily counters for keeping track of the number of times the track was played | | | | |
| | by this user on a given day of the week. | | | | |
| TimeLastPlayed | System.Storage.DateTime | true | | | False |
| | Time at which this track was last played by this user. | | | | |
| TotalPlays | System.Storage.Int32 | true | | | False |
| | Total number of plays. | | | | |
| SkippedDuringPlayback | System.Storage.Int32 | true | | | False |
| | Total number of times this track was skipped. | | | | |
| StoppedDuringPlayback | System.Storage.Int32 | true | | | False |
| | Total number of times this track was stopped. | | | | |
| SeekedDuringPlayback | System.Storage.Int32 | true | | | False |
| | Total number of times this track was seeked. | | | | |
| DoNotEverPlayThisTrack | System.Storage.Boolean | true | | | False |

User does not like this track.

The following table provides an exemplary ListeningHabitslog type. In general, this type can be associated with a user with respect to a track. It can be utilized for customizing the music playing experience of a user on a per-user, per-media data with ACLs on each record for the “owner”. It can include a plurality of instances (e.g., over many months) related to media playback. In addition, an application can process and/or clean up the data and generate a summary table that honors the natural temporal decay of media listening habits. It can be derived from System.Storage.Item.

| | | | | Change | Content |
|---|---|---|---|---|---|
| Property Name | Type | Nullable | Default | Unit | Indexed |
| UserId | System.Storage.Binary (85) | false | | | False |
| | The SID of the user whose listening habit logs are captured here. | | | | |
| MediaContentId | System.Storage.Guid | false | | | False |
| | The ID of the Media Content. This comes from the track. | | | | |
| MediaId | System.Storage.Guid | false | | | False |
| | Id of the Media refered here. Since the logs may reside for a long time and | | | | |
| | these relationships may not be traversed regularly, the Media Id is kept here as | | | | |
| | foreign key that can be used for query purpose. | | | | |
| Value | System.Storage.Int32 | false | | | False |
| | Specially coded integer value for keeping the data compact. | | | | |
| Weight | System.Storage.Int32 | false | | | False |

This is an app specific data for providing weight for this data.

Extension Types

The following table provides an exemplary Artistlnformation type. This type can provide for intelligent grouping. It can be derived from System.Storage.Extension.

| Property | | | | Change | Content |
|---|---|---|---|---|---|
| Name | Type | Nullable | Default | Unit | Indexed |
| ArtistGenre | MultiSet< | true | | | False |
| | System.Storage.Media.MVString128 > | | | | |
| | Genre refers to the kind music type the Artist is categorized with. Examples: | | | | |
| | Rock, Blues, Jazz, Electronic, etc. | | | | |
| ArtistStyle | MultiSet< | true | | | False |
| | System.Storage.Media.MVString128 > | | | | |
| | Style reflects the music styles that the artist's work is associated with. | | | | |
| ArtistRating | MultiSet< | true | | | False |
| | System.Storage.Media.Rating > | | | | |

An artist may be rated by different agencies for quality, parental advisory, etc.
This field is computed by an application using this extension.

Relationship Types

The following table provides an exemplary TrackAlbum type. In general, this type can represent a link from a Track to an associated Album. For example, a track typically includes information regarding its source. When the track is received, the information included with the track can be utilized to create a perceived relationship that identifies its source. When the actual source is identified, the perceived relationship can be utilized and associated with the actual source. This type can be derived from System.Storage.Relationship. Its source type is System.Storage.Audio.AudioRecord and its target type is System.Storage.Audio.CachedAlbum.

| | | | | Change | Content |
|---|---|---|---|---|---|
| Property Name | Type | Nullable | Default | Unit | Indexed |
| PartOfSet | System.Storage.String (16) | true | | | False |
| | PartOfSet indicates album's relation to a box set containing it (e.g. 2 | | | | |
| | of 5). This is persisted as part of the track information and can get out | | | | |
| | of sync from a similar property on the Album | | | | |
| AlbumArtistName | System.Storage.String (1024) | true | | | true |
| | The display name of the Album Artist as it was noted in the Track. | | | | |
| | This may be different from the Single name of the Album Artist - it | | | | |
| | may be misspelled, modified, etc. We must capture it since it is a | | | | |
| | part of the original track data. The Album Item will contain a correct | | | | |
| | Artist name for the Album. | | | | |
| AlbumArtistNameSortOrder | System.Storage.String (1024) | true | | | False |
| | AlbumArtistNameSortOrder is the sort order for the AlbumArtistName | | | | |
| | (e.g. “The Beatles” will have SortOrder “Beatles”). | | | | |
| CollectionGroupID | System.Storage.Guid | true | | | False |
| | CollectionGroupID is the Windows Media Information Service box set | | | | |
| | identifier (when a bunch of albums are sold together as a box set). | | | | |
| CollectionID | System.Storage.Guid | true | | | False |
| | CollectionID is the Windows Media Information Service album | | | | |
| | identifier. | | | | |
| IsFakeTitle | System.Storage.Boolean | true | false | | False |
| | There are cases when a document does not have a Single title and | | | | |
| | an application provides a substitute fake title for it. Usually in this | | | | |
| | case the file name is just copied into the Title field. This field is | | | | |
| | needed to distinguish the Single User-defined Title from a fake title | | | | |
| | generated by application. | | | | |
| Title | System.Storage.String (1024) | true | | | true |
| | The title of the Album as it was noted in the Track. This may be | | | | |
| | different from the Single Album Title - it may be misspelled, modified, | | | | |
| | etc. We must capture it since it is a part of the original track data. | | | | |
| | The Album Item will contain a proper canonical Title of the Album. | | | | |
| TitleSortOrder | System.Storage.String (1024) | true | | | False |
| | TitleSortOrder is the sort order of the Album title (e.g. “The Beatles” | | | | |
| | will have SortOrder “Beatles”). | | | | |
| TrackNumber | System.Storage.Int32 | true | | | False |
| | The track number of the track in the Album. | | | | |
| IsCompilation | System.Storage.Boolean | true | | | False |
| | Boolean saying that the album is a compilation of tracks from | | | | |
| | “Various artists”. | | | | |
| AlwaysPlayWithNext | System.Storage.Boolean | true | | | False |
| | Boolean indicates the song should be “hooked up” to the next one | | | | |
| | during playback in a playlist. It is the application's responsibility to | | | | |
| | apply the playing order by interpreting this flag. | | | | |
| PlayGapless | System.Storage.Boolean | true | | | False |
| | Boolean indicates the song should be “played without gap”. This | | | | |
| | needs to be interpreted and applied by the application playing the | | | | |
| | song. | | | | |
| ArtistId | System.Storage.Guid | true | | | False |

Artist Id information coming from the track.

The following table provides an exemplary SuggestedMetadata type. In general, this type can represent a set of links to track metadata. It can be derived from System.Storage.Relationship. Its source type is System.Storage.Audio.AudioRecord and its target type is System.Storage.Audio.CachedTrack.

| | | | | Change | Content |
|---|---|---|---|---|---|
| Property Name | Type | Nullable | Default | Unit | Indexed |
| Confidence | System.Storage.Double | false | 0.0 | | False |

Confidence in this particular match, as returned by the metadata provider.

The following table provides an exemplary RadioStationContentDistributor type. It can be derived from System.Storage.Relationship. Its source type is System.Storage.Audio.RadioStation and its target type is System.Storage.Core.Contact.

| Property | | | | Change | Content |
|---|---|---|---|---|---|
| Name | Type | Nullable | Default | Unit | Indexed |
| Data | System.Storage.Media.ContentDistributorData | true | | | False |

ContentDistributor refers to the distributor of the content. Examples: Clear Channel,
MSN Music, Pressplay, Radio Free Virgin, etc.

The following table provides an exemplary RadioStationLocation type. In general, this type can represent a location of the programming origin. It can be derived from System.Storage.Relationship. Its source type is System.Storage.Audio.RadioStation and its target type is System.Storage.Core.Location.

| | | | | Change | Content |
|---|---|---|---|---|---|
| Property Name | Type | Nullable | Default | Unit | Indexed |
| City | System.Storage.String (128) | true | | | False |
| | The City of the location. | | | | |
| Country | System.Storage.String (128) | true | | | False |
| | The Country of the location. | | | | |
| Region | System.Storage.String (128) | true | | | False |

The State/Region of the location.

The RadioStationLogo type can represent a link to an image that includes a graphic of the logo of the radio station. It can be derived from System.Storage.Relationship. Its source type is System.Storage.Audio.RadioStation and its target type is System.Storage.Core.Document.

The RadioStationStreams type can represent a collection of streams that the radio station can provide. It can be derived from System.Storage.Relationship. Its source type is System.Storage.Audio.RadioStation and its target type is System.Storage.Audio.RadioStream.

The Listeners type can provide a relationship to a listener. It can be derived from System.Storage.Relationship. Its source type is System.Storage.Audio.ListeningHabits and its target type is System.Storage.Core.Contact.

The ListenedTrack type can provide a relationship to a listened track. It can be derived from System.Storage.Relationship. Its source type is System.Storage.Audio.ListeningHabits and its target type is System.Storage.Audio.Track.

Nested Types

The following table provides an exemplary AutoDJ type. In general, this type can be utilized in connection with an algorithm to create one or more playlists via analyzing tracks. It can be derived from System.Storage.NestedType.

| | | | | Change | Content |
|---|---|---|---|---|---|
| Property Name | Type | Nullable | Default | Unit | Indexed |
| A01 | System.Storage.Single | true | | | False |
| | Technical field storing algorithm-specific information. | | | | |
| A02 | System.Storage.Single | true | | | False |
| | Technical field storing algorithm-specific information. | | | | |
| A03 | System.Storage.Single | true | | | False |
| | Technical field storing algorithm-specific information. | | | | |
| A04 | System.Storage.Single | true | | | False |
| | Technical field storing algorithm-specific information. | | | | |
| A05 | System.Storage.Single | true | | | False |
| | Technical field storing algorithm-specific information. | | | | |
| A06 | System.Storage.Single | true | | | False |
| | Technical field storing algorithm-specific information. | | | | |
| A07 | System.Storage.Single | true | | | False |
| | Technical field storing algorithm-specific information. | | | | |
| A08 | System.Storage.Single | true | | | False |
| | Technical field storing algorithm-specific information. | | | | |
| A09 | System.Storage.Single | true | | | False |
| | Technical field storing algorithm-specific information. | | | | |
| A10 | System.Storage.Single | true | | | False |
| | Technical field storing algorithm-specific information. | | | | |
| A11 | System.Storage.Single | true | | | False |
| | Technical field storing algorithm-specific information. | | | | |
| A12 | System.Storage.Single | true | | | False |
| | Technical field storing algorithm-specific information. | | | | |
| A13 | System.Storage.Single | true | | | False |
| | Technical field storing algorithm-specific information. | | | | |
| A14 | System.Storage.Single | true | | | False |
| | Technical field storing algorithm-specific information. | | | | |
| A15 | System.Storage.Single | true | | | False |
| | Technical field storing algorithm-specific information. | | | | |
| A16 | System.Storage.Single | true | | | False |
| | Technical field storing algorithm-specific information. | | | | |
| A17 | System.Storage.Single | true | | | False |
| | Technical field storing algorithm-specific information. | | | | |
| A18 | System.Storage.Single | true | | | False |
| | Technical field storing algorithm-specific information. | | | | |
| A19 | System.Storage.Single | true | | | False |
| | Technical field storing algorithm-specific information. | | | | |
| A20 | System.Storage.Single | true | | | False |
| | Technical field storing algorithm-specific information. | | | | |
| PerceivedSongID | System.Storage.Guid | true | | | False |

PerceivedSongID is the id the AutoDJ algorithm assigns to the song.
The main idea is that all remixes of the same song will have the
same PerceivedSongID.

The following table provides exemplary PlayCounter type. In general, this type can be utilized to keep track of the number of times a track is played (e.g., hourly, daily, etc.). It can be derived from System.Storage.NestedType.

| | | | | Change | Content |
|---|---|---|---|---|---|
| Property Name | Type | Nullable | Default | Unit | Indexed |
| DayTime | System.Storage.String (32) | false | | | False |
| | Indicates the day (monday, tuesday etc) or the hour (1, 2, . . . 24) | | | | |
| | for which the counter applies. | | | | |
| Value | System.Storage.Int32 | true | | | False |

Total number of plays durin this time period.

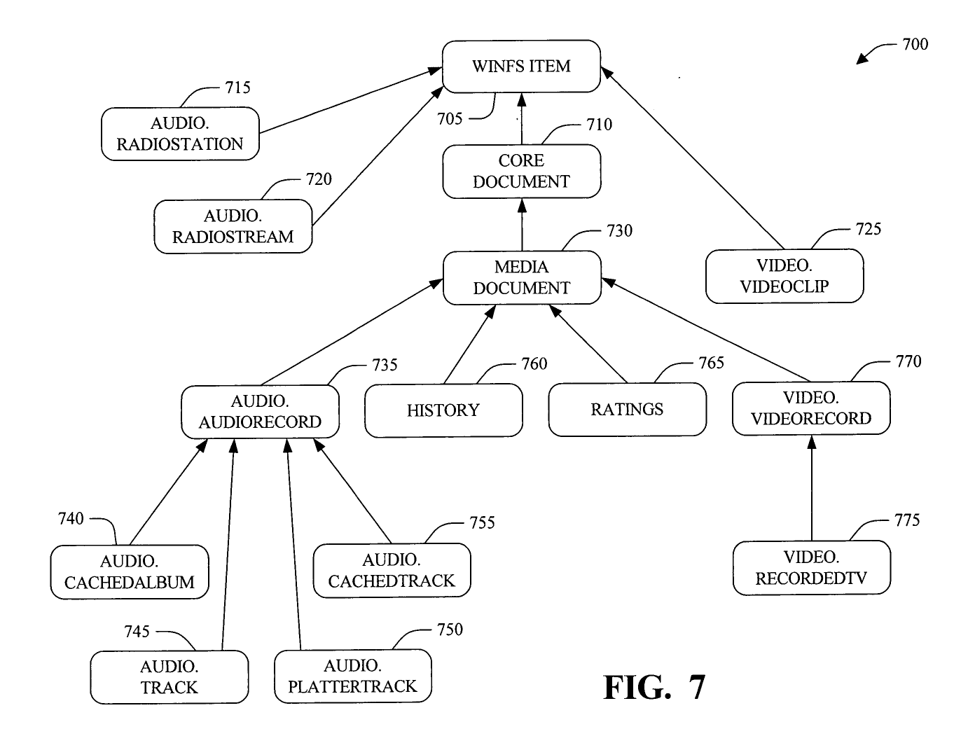

FIG. 7 illustrates several exemplary relationships between the above-described schema. It is noted that other relationships can be formed but are not illustrated for sake of brevity. As depicted, a WINFS Item type 705 can be a base type. A Core.Document type 710, an Audio.RadioStation type 715, an Audio.RadioStream type 720, and a Video.VideoClip type 725 can be derived from the WINES Item type 705. A Media.Document type 730 can be derived from the Core.Document type 710.

An Audio.AudioRecord type 735 can be derived from the Media.Document type 730. The Audio.AudioRecord type 735 can be utilized to derive an Audio.CachedAlbum type 740, an Audio.Track type 745, an Audio.PlatterTrack type 750 and an Audio.CachedTrack type 755. In general, Audio.Track type 745 corresponds to metadata for ripped audio files, Audio.PlatterTrack type 750 corresponds to track on an audio CD, and Audio.CachedTrack type 755 corresponds to downloaded metadata. A SuggestedMetadata relationship can be established that associates the Audio.Track type 745 or Audio.PlatterTrack type 750 with metadata in the Audio.CachedTrack type 755.

In addition, a History type 760 and a Ratings type 765 can be derived from the Media.Document type 730. Furthermore, a Video.VideoRecord type 770 can be derived from the Media.Document type 730, wherein a Video.RecordedTV type 775 can be derived from the Video.VideoRecord type 770.

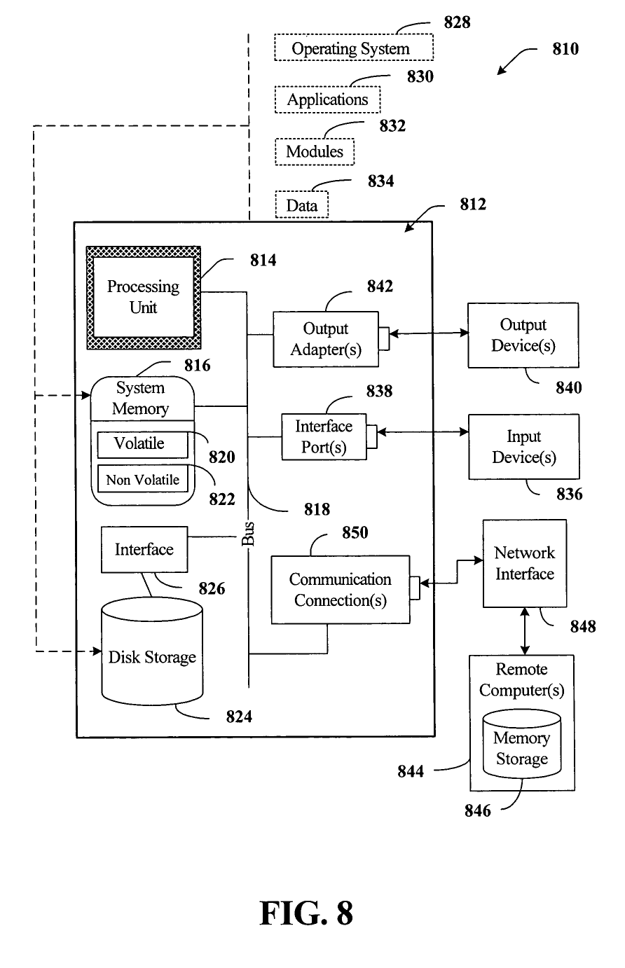

With reference to FIG. 8, an exemplary environment 810 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/nonremovable, volatile/nonvolatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the present invention can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers among other output devices 840 that require special adapters. The output adapters 842 include, by way of illustration and not limitation, video and sound cards that provide a means of connection between the output device 840 and the system bus 818. It should be noted that other devices and/or systems of devices provide input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications, and variations that fall within the spirit and scope of the appended claims. In addition, while a particular feature of the invention may have been disclosed with respect to only one of several implementations, such feature may be combined with one or more other features of the other implementations as may be desired and advantageous for any given or particular application. Furthermore, to the extent that the term “includes” and variants thereof are used in the detailed description or the claims, these terms are intended to be inclusive in a manner similar to the term “comprising.”

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

1. A platform that manages disparate files, comprising:
a management component, and
a multimedia file system, wherein the management component manages the disparate files as one entity of data within the multimedia file system.

2. The system of claim 1, the disparate files comprise one or more of audio, video, image and document files.

3. The system of claim 1, the management component establishes links between disparate files via forming relationships with one or more contact items.

4. The system of claim 3, the management component utilizes the one or more contact items in connection with querying across and within the disparate files.

5. The system of claim 3, the one or more contact items include one or more of information related to a phone number, an address and a link to emails.

6. The system of claim 1, the management component locates, associates and suggests metadata for a received file, the suggested metadata includes information indicative of a level confidence that the suggested metadata corresponds to the received file.

7. The system of claim 6, at least one of the suggested metadata is manually selected by user or automatically selected by the management component and associated with the file.

8. The system of claim 1, the management component resolves an association between a received file and an originating source of the received file.

9. The system of claim 8, the management component stores an original and the resolved association with the received file.

10. The system of claim 1, the management component associates one or more ratings with a file.

11. The system of claim 10, the one or more ratings comprises one or more of a parental, a quality and a user rating.

12. The system of claim 10, the one or more ratings is associated with one or more of an audio, a movie and a television rating.

13. The system of claim 10, the one or more ratings is employed in connection with querying across the disparate files.

14. The system of claim 1, the management component maintains a history of a stored file.

15. The system of claim 14, the file history is utilized in connection with intelligent decision-making to automate at least one of execution, manipulation and access to the file.

16. The system of claim 1, the management component generates one or more sub-parts for video, the sub-parts are associated with respective portions of the video and can be utilized to return to respective portions of the video.

17. A file system that manages at least one of disparate audio and video data based on schema, comprising:
a schema bank with schema stored therein; and
a data management component that utilizes the schema to facilitate saving, manipulating and retrieving the at least one of disparate audio and video data from a data store.

18. The system of claim 17, the schema comprises at least one of a media, an audio and a video schema.

19. The system of claim 18, the audio and video schema are derived from at least one of the media schema and an item schema.

20. The system of claim 17, the schema provides a framework for an application developer to arbitrarily generate an application that works uniformly across and within the at least one of disparate audio and video data.

21. The system of claim 17 is incorporated within an operating system.

22. The system of claim 17, the schema provides for seamless identification, differentiation and access to the at least one of disparate audio and video data stored within the data store.

23. A multimedia platform, comprising:
a database;
a plurality of schemas associated with audio and video data; and
a component that utilizes the plurality of schemas to systematically store and access at least one of disparate audio and video data within the database.

24. The system of claim 23, the plurality of database schemas comprises domain-specific properties associated with the at least one of disparate audio and video data.

25. The system of claim 23, further comprising intelligence that facilitates storage and access of the at least one of disparate audio and video data via one or more of a statistic, a probability, an inference and a classifier.

26. The system of claim 23, the intelligence is configured by a user to define a level of confidence that determines a degree of automation.

27. An API that facilitates audio and video file management, comprising:
receiving at least one of disparate audio and video data from an application;
obtaining schema associated with the received data; and
systematically storing and managing the received data based on the associated schema.

28. The API of claim 27 is generated based on one or more of a media, an audio and a video schema.

29. The API of claim 27 is employed by an application developer to arbitrarily create an application that works uniformly across and/or within the stored data.

30. The API of claim 27 is employed in connection with an operating system.

31. A method that schematizes audio and video files, comprising:
receiving an audio or video file;
determining the type of file;
obtaining a schema associated with the identified type; and
storing the file within a file system based on the schema.

32. The method of claim 31, further comprising receiving a request for a stored file and utilizing the schema to locate and return the file.

33. A rich multimedia schema-based system, comprising:
a schema set;
a component that utilizes the schema set to manage disparate audio and video data within a database.

34. The system of claim 33, the schema set comprises a media schema that comprises one or more of the following types: an EffectiveBackCoverArt; an EffectiveFrontCoverArt; a MetadataProviderLogo; a Document; a MetadataLifecycle; a ContentDistributor; a ContentDistributorData; a History; a Rating; a CustomRating; a StarRating; a URLReference; a MVString128, and a MVString256.

35. The system of claim 34, the Document type is an item type.

36. The system of claim 34, the MetadataLifecycle type is an extension type.

37. The system of claim 34, the ContentDistributor, EffectiveBackCoverArt, EffectiveFrontCoverArt, and MetadataProviderLogo types are relationship types.

38. The system of claim 34, the ContentDistributorData, History, Rating, CustomRating, StarRating, URLReference, MVString128, and MVString256 types are nested types.

39. The system of claim 33, the schema set comprises a video schema that comprises one or more of the following types: a Clips; a VideoRecord; a RecordedTV; a VideoClip, and a VideoSubShot.

40. The system of claim 39, the VideoRecord, RecordedTV and VideoClip types are item types.

41. The system of claim 39, the Clips type is a relationship type.

42. The system of claim 39, the VideoSubShot type is a nested type.

43. The system of claim 33, the schema set comprises an audio schema that comprises one or more of the following types: a RadioStationLogo; a RadioStationStreams; a Listeners, a ListenedTrack; a CachedAlbum; an AudioRecord; a Track; a CachedTrack; a PlatterTrack; a PlayList; a RadioStation; a RadioStream; a ListeningHabits; a Listeninghabitslog; an ArtistInformation; a TrackAlbum; a SuggestedMetadata; a RadioStationContentDistributor; a RadioStationLocation; an AutoDJ, and PlayCounter.

44. The system of claim 43, the CachedAlbum, AudioRecord, Track, CachedTrack, PlatterTrack, PlayList, RadioStation, RadioStream, ListeningHabits, and Listeninghabitslog types are item types.

45. The system of claim 43, the ArtistInformation type is an extension type.

46. The system of claim 43, the TrackAlbum, SuggestedMetadata, RadioStationContentDistributor, RadioStationLocation, RadioStationLogo, RadioStationStreams, Listeners, and ListenedTrack types are relationship types.

47. The system of claim 43, the AutoDJ, and PlayCounter types are nested types.

48. A data packet transmitted between two or more computer components that facilitates management of disparate audio and video data within a file system, comprising:
a component that receives audio or video data, a component that obtains a schema associated with the received data, a component that utilizes the schema to systematically store the data, and a component that utilizes the schema to manage the stored data.

49. A computer readable medium that stores computer executable components of a file management system, comprising:
a schema bank that stores rich audio and video-based schema sets;
an interface; and
a component that receives at least one of audio and video data through the interface and obtains an associated schema from the schema bank to manage the received data.

50. An audio/video management system that stores and retrieves audio and video files based on audio/video schema, comprising:
means for accepting audio and video files;
means for obtaining a schema related to the audio and video files; and
means for utilizing the schema to manage the audio and video file within a database.
